(19) United States
(12) Patent Application Publication
(10) Pub. No.: US 2003/0206763 A1
(43) Pub. Date: Nov. 6, 2003

(54) System and method for improving feed ability of consumable electrode in wire feed welding apparatus

(76) Inventor: Leon Merle Troup, Marquette, MI (US)

Correspondence Address: EDWARD D. GILHOOLY, 28 E. JACKSON BLVD., SUITE 423, CHICAGO, IL, 60604, US

(21) Appl. No.: 10/425,479

(22) Filed: Apr. 29, 2003

Related U.S. Application Data
(60) Provisional application No. 60/377,191, filed on May 2, 2002.

(51) Int. Cl. A46B 15/00; B43K 8/16

(52) U.S. Cl. 401/9; 401/196

(57) ABSTRACT

A method and assembly for applying a liquid solution of a hydrocarbon, such as mineral spirits, and a solvent, such as Naphtha, to welding wire being conveyed to a welding electrode in a welding system for increasing feed ability, cleansing weld wire and increasing electrical conductivity. An applicator assembly containing the solution is mounted adjacent the weld wire at apposition between the weld wire supply and the weld gun. The applicator assembly may include a replenishable absorbent member such as a felt pad, to apply the solution.

This application claims benefit to the filing date of provisional application, serial No. 60/377,191 filed May 2, 2002.

### BACKGROUND OF THE INVENTION

1. Field of the Invention

This invention relates in general to welding apparatus and, more specifically, to an improved system and method for increasing the feed ability of consumable electrode wire in a wire feed welding apparatus.

2. Summary of the Prior Art

In conventional MIG (GMAW) wire feed welding apparatus, the consumable electrode (wire) is drawn from a wire supply spool by drive rollers, which push the wire through a flexible conduit to the gun held by the operator, and through a contact tip at the end of the gun, to the work piece being welded. This system has, for welding with steel wire, has been effective for the most part. There are smaller diameter stainless steel, har5d facing and hollow core steel wires that because of their low columnar strength and their tendency to deform, are prone to bum back to the contact tip and “bird nest” in the drive rollers. Despite the continued results in the use of steel wire, the use of aluminum wire in conventional MIG (GMAW) wire feed welding apparatus and the like have not attained similar success.

One serious drawback in using consumable aluminum electrodes (wire) relates to the problems in efficiently feeding the aluminum wire through the conventional MIG (GMAW) wire feed welding equipment, including through the flexible gun conduit and contact tip. Consumable aluminum electrode (wire) has a very low columnar strength and is easily deformed because of its high malleability, which makes it difficult, if not impossible, to consistently push the wire through a standard wire feed system with sufficient force to overcome the friction in the flexible conduit and contact tip that conducts electricity to create the arc for welding. Typically, the aluminum wire being fed will hesitate and the welding arc will burn back to the contact tip. As a result, the wire will melt and fuse into the contact tip causing the driven wire to wind around the drive rollers. The latter problem requires the replacement of the contact tip and time consuming and inefficient removal of the aluminum wire from the drive rollers and flexible wire conduit assembly. The wire then must be refed through the drive rollers and out through the contact tip.

Many attempts have been made to overcome the foregoing problems in using aluminum wire when MIG (GMAW) wire feed welding. One such attempt is by using a spool gun that is attached to a new MIG wire feed welder, or adapted to an older MIG wire feed welder. Although the spool gun is effective when welding with aluminum weld wire, it has several drawbacks. Because the gun is large and heavy, the spool gun causes problems in welding in tight confines and its weight makes it awkward to use. A spool gun commonly uses one pound rolls of aluminum welding wire and when welding the spool must frequently be changed. The aluminum wire for the spool gun is more expensive and frequent changing of the wire is time consuming. Contact tips and repair parts for the spool gun are also expensive and not frequently stocked at welding supply houses. Beside the foregoing shortcomings, know spool guns are not provided with a heater, and when the aluminum wire is cool, the temperature often contributes to poor weld quality and to burn back and fusing the contact tip.

Push-Pull wire feed welding systems were developed to overcome the difficulties encountered when welding with aluminum wires. Known push-pull equipment utilizes a wire drive system that pushes the wire to the head of the gun, and a small drive motor and drive rollers in the head of the gun pulls the aluminum wire and pushes the wire through a short liner and the contact tip. The push-pull system suffers from several of the shortcomings of the spool gun with use aluminum wire. The welding gun of a push-pull welder is larger and heavier than a standard MIG wire feed welding gun to present problems in use. In addition, an effective push-pull system, such as sold under the Cobra trademark, is relatively expensive, while its parts are also expensive and not frequently stocked. Push-pull systems also commonly encounter problems in passing aluminum welding wire over long distances and if the wire is cool, burn back problems are encountered. Because of the problems in the prior art in using aluminum wire for welding, including spool guns and push-pull—wire feed welding systems, certain advantages of using aluminum wire in wire feed welding have not been successfully attained in an economic manner in the prior art. Accordingly, it is desirable in the industry to provide an economic and effective system and method for using aluminum weld wire.

### SUMMARY OF THE INVENTION

It is therefore an objective of the invention to provide a system and method for improving feed ability of consumable electrode in wire feed welding apparatus. Not only does the invention of the application perform with highly satisfactory results with stainless steel, steel wire, and the like, it provides particularly superior results with aluminum weld wire, which heretofore has been difficult to use with effective results in welding. The system and method herein disclosed can readily be installed on existing known guns or push-pull systems and even in conventional MIG (GMAW) wire feed welders.

In accordance with the invention, the weld wire acting as an consumable electrode is passed through an applicator means that conditions the wire and applies a microscopic coating of solution to the surface of the wire. The solution can be a petroleum hydrocarbon, such as mineral spirits, which demonstrates highly satisfactory results. A solvent to be identified later can dilute the mineral spirit and the like. The microscopic surface coating cleans the wire as it passes through the conditioner pad for better weld quality, reduces the coefficient of friction of the wire, which improves feed ability, and increases conductivity of electricity from the contact tip to the wire. The coating is designed to evaporate as the wire exits from the gun and approaches the welding arc, so that the coating does not interfere with the welding process and achieves a cleaner weld through the evaporation process.

Further in accordance with the invention, the wire can optionally be heated to a level to relax the wire to diminish the tendency of the wire to retain the memory of the supply coil. The relaxation of the wire results in reduced friction generated in the liner for increase feed ability of the wire. As an additional benefit, the application of heat increases the benefits of the microscopic coating and the ability of the contact tip to transfer current to the wire herein disclosed.

### BRIEF DESCRIPTION OF THE DRAWINGS

FIG. 1 is a side elevation view of a wire feed welder having the system for propelling wire of the invention and

FIG. 2 is enlarged side elevation view, with parts in section, of the felt applicator assembly of FIG. 1.

### DESCRIPTION OF THE PREFERRED EMBODIMENT

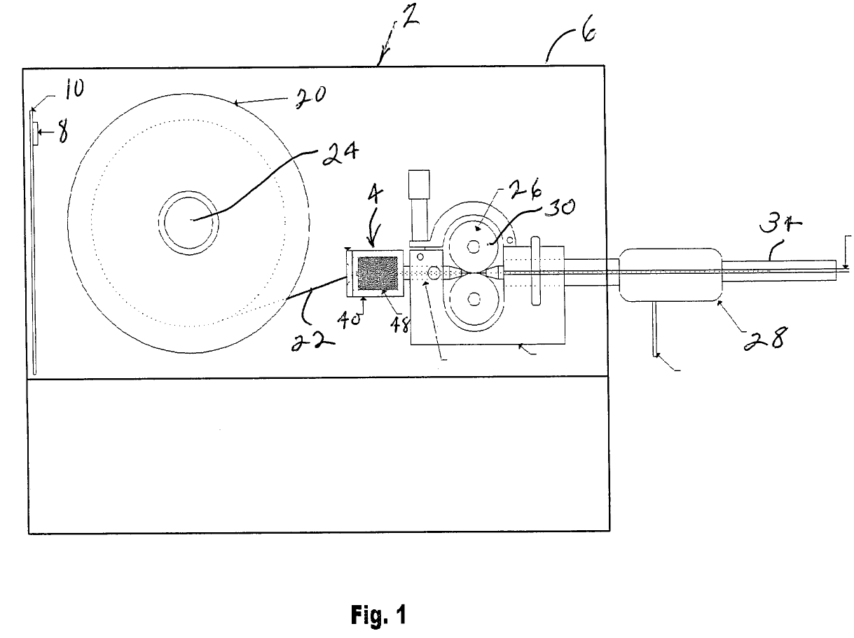

Referring to FIG. 1, there is illustrated a typical enclosed MIG wire feed welder, generally designated by reference numeral 2, employing the system and method of propelling wire in a welding apparatus, generally designated as wire propellant system 4. Although the invention provides superior results with aluminum weld wire, it may also be used with steel and stainless steel weld wire with enhanced performance characteristics for improved feed and welds. A typical enclosed MIG wire feed welder in which the wire propellant system 4 can be incorporated is sold under the trademark Millermatic 250X by the Miller Electric Mfg. Co. The wire propellant system 4 can be used in other welding equipment, including other existing MIG wire feed welders, robot welders and be installed on a OEM basis on a welding apparatus.

In FIG. 1, the welder 2 is shown having housing 6. The housing is provided with flexible silicone resistance heater 8 adjacent an aluminum heat sink 10. Other types of heaters for heating the wire may alternatively employed and may also be mounted outside of the housing 6 with heated air being directed directly into the housing 6. The heater controls the internal temperature of the housing 6 to 75 to 95 degrees Fahrenheit to maintain the wire in the same temperature range.

A feed spool 20 of welding wire 22 is mounted on rotating shaft 24 that allows the roll to unwind as driver assembly 26 pushes wire through a gun assembly 28. The gun assembly 28 is of a standard design to convey welding wire, shielding gas and electricity to the work piece (not shown) to be welded. The gun assembly 28 may be either a push-pull or spool gun. The wire 22 is driven by drive rollers 30 within the driver assembly 26. The rollers may be knurled or have another design for propelling wire through the liner 34 which guides the wire 22 from the drive rollers 30 to the gun assembly 28 and out through the contact tip. The liner 34 conventionally is formed from a Teflon or Nylon material.

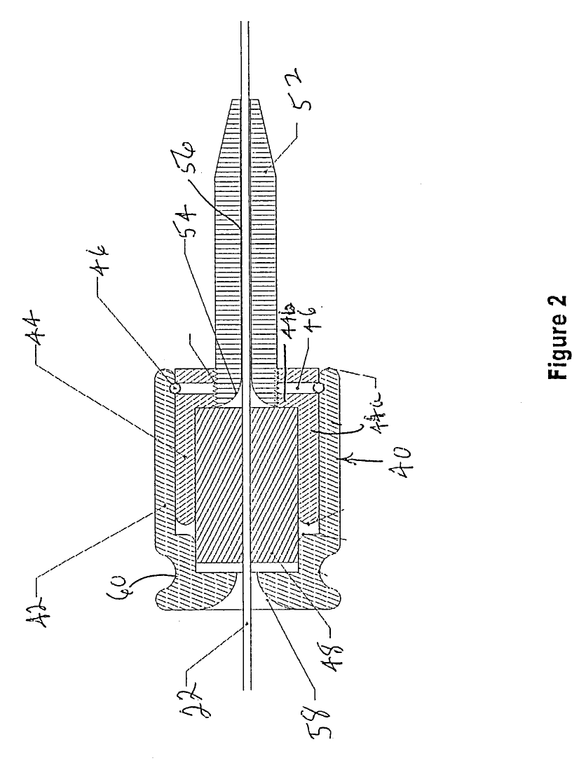

As seen in FIGS. 1 and 2, an applicator member, such as felt pad assembly 40 is mounted adjacent to drive assembly 26 and receives the weld wire 22 as it is fed to the driver assembly. Although the invention is described employing felt pad assembly 40, it is within the scope of the invention to use other applicator techniques using other types of absorbent members of sprayers mounted adjacent the wire. The felt pad assembly 40 is intended to mounted on existing welding equipment or being incorporated as a component of new welding systems being manufactured. The felt pad assembly 40 includes an outer guide 42 made of plastic and the like and an inner felt pad retainer 44. An O-ring 46 locates and secures the outer guide 42 to felt pad retainer 44 in sealed relationship. The felt pad retainer 44 retains a cylindrical felt pad 48 having an opening 50 through which the wire passes, The felt pad 48 can be fabricated from felt or other absorbent material capable of retaining and applying an even microscopic coating to the wire. The felt pad 48 also acts to clean the wire 22 as the felt pad contacts the wire for better weld quality. The felt pad retainer 44 includes a cylindrical wall 44a and base 44b to contact the felt pad 48 in a proper compression on the wire 22. The wire 22 is guided after contact with the felt pad by a plastic wire guide 52 having a tapered inlet 54 and a center bore 56 for receiving the wire. The retainer 42 has a radiused inlet 58 to permit the wire to enter retainer 42 without chafing or scratching and to aid in the smooth transfer of wire from the roll as it unwinds. An annular depression 60 serves as a gripping area to remove the felt retainer for changing the felt pad or replenishing the pad.

The felt pad retainer 44 is threaded through its base to the end of the wire guide to permit interchanging different diameter wire guides to match the bore of the receiver in the wire drive roll system. As the wire passes through the retainer 42 and felt pad 48, a thin coating of solution in the form of a mixture of a lubricant and a solvent to be described is applied to the wire to clean the wire, lubricate the wire, and serve as an agent to assist the conduction of electrical current from the contact tip to the wire. The felt pad 48 is consumable and must be replenished with solution at regular intervals by injection from source (not shown) or a timed interval pump (not shown). When the wire 22 enters the arc when welding, the solution is vaporized in front of the weld puddle. This results in a weld that needs little cleaning of wire brushing. A solution that has proven effective in accordance with the invention is a 50% to 50% mixture of a petroleum hydrocarbon, such as, for example, mineral spirits, and a solvent, such as Naphtha. Under suitable the mineral spirits may comprise up to approximately 95% of the solution or less tha 50% of the solution. Other solvents may also be used as an agent with the petroleum hydrocarbon to achieve the advantages of the invention, such as Acetone, Toluene, Carbo-sol, or similar solvents

What is claimed is:

1 A method of improving the feed ability of weld wire through a welding system comprising the steps of
delivering the weld wire to the welding system,
conveying the weld wire to gun assembly generating a welding arc, and
applying a liquid solution of a hydrocarbon and a diluting solvent to the weld wire being conveyed to the gun assembly.

2. The method according to claim 1 further comprising the step of substantially evaporating said solution prior to the weld wire exiting said gun assembly before the welding arc.

3. The method according to claim 1 wherein said solution is applied by an applicator assembly.

4. The method according to claim 3 wherein said applicator assembly includes means mounted adjacent the weld wire for applying said solution to said weld wire.

5. The method according to claim 4 wherein said solution is applied by an absorbent member containing said solution and contacting the weld wire to apply said solution to said the weld wire.

6. The method according to claim 4 wherein said hydrocarbon is mineral spirits.

7. The method according to claim 5 wherein said absorbent member is an absorbent pad.

8. The method according to claim 7 wherein said absorbent pad is a felt pad.

9. The method according to claim 4. wherein said solution is applied to weld wire as an even microscopic layer

10. An applicator assembly for applying a solution to the surface of the weld wire being conveyed in a welding system to a electrode gun producing a weld arc comprising
housing means for being mounted adjacent the weld wire being conveyed in the welding system,
said housing means having applicator means for applying a layer of a liquid solution of a hydrocarbon and a solvent on the surface of the weld wire, and
said solution acting to increase conductivity, reduce friction and increase feed ability of said weld wire.

11. The applicator assembly according to claim 10 wherein applicator means is an absorbent member capable of retaining said solution and applying said layer on the surface of the weld wire.

12. The applicator assembly according to claim 11 wherein said absorbent member in generally in contact with the surface of the weld wire.

13. The applicator assembly according to claim 12 wherein said absorbent member is formed from felt.

14. The applicator assembly according to claim 13 further comprising means for periodically replenishing the supply of the solution retained by said applicator means.

15. The applicator assembly according to claim 1 wherein hydrocarbon is mineral spirits.

16. The applicator assembly according to claim 15 wherein said solvent is Naphtha.

17. The applicator assembly according to claim 12 wherein said absorbent member cleans the wire.

18. The applicator assembly according to claim 10 further including means to heat the wire to increase the welding effect of said layer.
